(19) United States
(12) Patent Application Publication
(10) Pub. No.: US 2012/0201509 A1
(43) Pub. Date: Aug. 9, 2012

(54) INFORMATION DISTRIBUTION DEVICE AND METHOD FOR PROCESSING BIDIRECTIONAL OPERATIONS

(75) Inventors: Hideki Kamimaki, Fujisawa (JP); Nobuhiro Sekimoto, Yokohama (JP)

(73) Assignee: HITACHI, LTD., Tokyo (JP)

(21) Appl. No.: 13/500,465

(22) PCT Filed: Nov. 22, 2010
(86) PCT No.: PCT/JP2010/070814

§ 371 Date: Apr. 5, 2012

(30) Foreign Application Priority Data
Dec. 1, 2009 (JP) 2009-273446

(51) Int. Cl. H04N 5/765

(52) U.S. Cl. 386/234; 386/E05.002

(57) ABSTRACT

In order to watch existing contents by using different information apparatus, the contents are converted into formats suitable for respective information apparatus to be implemented, but implementation of interaction for bidirectionality is not solved. In order to implement watching the contents in all information receiving apparatus, a playback/capture content processing device, a content conversion unit, a content analysis processing unit extracting an operation object of a remote controller from converted video information, a distribution processing unit, and an interaction analysis/control unit are provided. The interaction analysis/control unit acquires operation information of a remote controller device in an information receiving apparatus side, preserves matching information with the operation object extracted by the content analysis processing unit in real time on a database, and controls content information of the playback/capture content processing device in real time.

### TECHNICAL FIELD

The present invention relates to an information distribution system for processing bidirectional operations by a user's operation, and more particularly, to an information distribution technology that facilitates an operation control of a user's remote controller in the information distribution system.

### BACKGROUND ART

In recent years, a video on demand (VOD) watching service and a TV target service have started being propagated as a bidirectional information providing system by an Internet protocol television (IPTV) and a content providing server and a content providing method that make an operation environment in only a remote controller pleasant in a content providing server of a center facility and automatically reproduce a thumbnail as supplemental information contents of a preview, that is, solve inconvenience in selecting a menu by operating the remote controller, have been proposed (see Patent Literature 1). Further, a method for implementing extraction of a keyword based on information such as a telop included in an image is proposed in order to search a video and search a scene (see Patent Literature 2).

### CITATION LIST

### Patent Literatures

Patent Literature 1: Japanese Patent Application Laid-Open Publication No. 2009-93357

Patent Literature 2: Japanese Patent Application Laid-Open Publication No. 2005-234786

### SUMMARY OF INVENTION

### Technical Problem

In the information distribution system in the related art, a method for providing contents to an information receiving terminal device in an information distribution server side distributing a requested video was proposed. However, in a remote controller device affiliated in a TV in the related art, since a content operation having high bidirectionality is not performed, when the remote controller device is not operated for a predetermined time, as only a start for a distribution server to automatically provide contents of a preview and a review for implementing interactivity of contents having high bidirectionality, which is produced for a personal computer (PC), is not performed. Similarly, in an IPTV target service in the related art, remaking contents matching numeric keys of the remote controller is required and a consideration of utilization of existing contents is not made. Further, in order to watch not only the video but also the existing contents in different information apparatus, TVs, or portable apparatus (i.e. smart phone and mobile phone), the existing contents are converted into formats which are suitable for the respective information apparatus to be implemented, but a consideration of interaction for bidirectionality is not made.

An object of the present invention is to construct an information distribution device, an information distribution system, and a method for processing bidirectional operations in which a center side distributing information can provide an interaction function in watching contents having high bidirectionality by a user's operation of a receiving terminal.

### Solution to Problem

In order to achieve the object, in the present invention, an information distribution device distributing contents to an information receiving terminal device includes: an interaction analysis/control unit analyzing a command of the information receiving terminal device; a content playback processing unit following control of the interaction analysis/control unit and playing back content data; a content conversion unit converting a format of the content data based on device information of the information receiving terminal device; a content analysis processing unit analyzing the content data, extracting an object such as an operation object or an area object in the content data, and overlaying the extracted object to the content data converted by the content conversion unit; and a distribution processing unit distributing the content data to which the operation object is overlaid.

Further, in order to achieve the object, an information distribution device distributing contents to an information receiving terminal device, includes: a processing unit processing content data; and a storage unit, wherein the processing unit plays back the content data based on a command from the information receiving terminal device, converts a format of the content data which is played back in accordance with device information of the information receiving terminal device, analyzes the content data, extracts an object in the content data, overlay-processes the extracted object to the converted content data, and distributes the content data which is overlay-processed.

Further, in order to achieve the object, in a method for processing bidirectional operations in an information distribution device with a processing unit distributing contents to an information receiving terminal device, the processing unit plays back the content data based on a command from the information receiving terminal device, converts a format of the content data which is played back in accordance with device information of the information receiving terminal device, analyzes the content data, extracts an object in the content data, overlay-processes the extracted object to the converted content data, and distributes the content data which is overlay-processed to the information receiving terminal device.

That is, in order to achieve the object, in one appropriate aspect of the present invention, an information distribution system for matching an information request operation by a user's operating a remote controller and processing bidirectional operations in real time includes an interaction analysis/control unit acquiring remote controller operation information, a content conversion unit for implementing watching contents in all information receiving apparatus, a playback/capture content processing device, a content analysis processing unit extracting an operation objet of a remote controller from video content information converted by the content conversion unit, and a distribution processing unit of the contents and the interaction analysis/control unit preserves and updates matching information of the acquired remote controller operation information and the operation object extracted from the content analysis processing unit in real time and further, controls content information played back by the playback/capture content processing device in real time.

Further, in another appropriate aspect of the present invention, in order to achieve the object, a display unit of the information receiving terminal may associate with area object information matching numeric key arrangements of the remote controller, the portable terminal, and the like.

In addition, in another appropriate aspect of the present invention, in order to achieve the object, the content analysis processing unit has a function to analyze an operation object of a telop such as text information, a menu button, and the like and a matching chart of a key code prepared by the interaction analysis/control unit and the operation object, screen information of the operation object, and the key code of the remote controller.

Further, the present invention is not limited to the numeric key of the remote controller and has a configuration to control an operation button to match the operation object and the area object one by one.

### ADVANTAGEOUS EFFECTS OF INVENTION

According to the present invention, even in contents which can be reproduced and watched but have lost bidirectionality by converting a format of captured contents after the contents are reproduced, a bidirectional information distribution system having high operability which can directly control an operation object without losing an operation environment can be provided.

### BRIEF DESCRIPTION OF DRAWINGS

FIG. 1 is a diagram showing one example of an overall configuration of an information distribution system according to each embodiment.

FIG. 2 is a functional block diagram showing one configuration of an information distribution system according to a first embodiment.

FIG. 3 is a diagram showing one example of displaying playback/capture contents according to the first embodiment.

FIG. 4 is a diagram showing one example of displaying captured video analysis result contents according to the first embodiment.

FIG. 5 is a diagram showing one example of displaying a key code overlay according to the first embodiment.

FIG. 6A is a diagram showing one example of an operation object/a key code chart according to the first embodiment.

FIG. 6B is a diagram showing one example of screen positional information of an operation object according to the first embodiment.

FIG. 7A is a diagram showing one example of a processing flow of the information distribution system according to the first embodiment.

FIG. 7B is a diagram showing one example of a processing flow of the information distribution system according to the first embodiment.

FIG. 8 is a diagram showing one example of displaying playback/capture contents according to a second embodiment.

FIG. 9 is a diagram showing one example of displaying a key code overlay according to the second embodiment.

FIG. 10 is a diagram showing another example of displaying a key code overlay according to the second embodiment.

FIG. 11 is a diagram showing one example of an operation object/an area object and a key code chart according to the second embodiment.

FIG. 12A is a diagram showing one example of arrangement of numeric keys of a TV remote controller according to the second embodiment.

FIG. 12B is a diagram showing one example of arrangement of numeric keys of a portable terminal according to the second embodiment.

FIG. 13 is a diagram showing one example of a processing flow of the information distribution system according to the second embodiment.

FIG. 14 is a diagram showing one example of a hardware configuration of an information distribution device according to each embodiment.

FIG. 15 is a diagram showing one example of displaying a key code overlay according to a modified example of the second embodiment.

FIG. 16 is a diagram showing one configuration of an overall system when a service is provided by a service portal according to a third embodiment.

FIG. 17 is a diagram showing one example of a processing sequence when the service is provided according to the third embodiment.

### DESCRIPTION OF EMBODIMENTS

Hereinafter, embodiments of the present invention will be described with reference to the accompanying drawings. Further, in the following description, only an information distribution device distributing information in an information distribution system of the present invention is called the information distribution system in some cases. Further, interaction means that a counterpart apparatus or system performs a reaction to an action such as a user's operation or action or vice versa. Further, in this specification, various programs executed by a processing unit of the information distribution device is called ‘units’ and ‘functions’ in some cases. For example, a content analysis processing program is called a ‘content analysis processing unit’, a ‘content analysis processing function’, or the like. Further, an operation object and an area object is collectively called an object in some cases.

### First Embodiment

A first embodiment is an information distribution system in which a content analysis processing unit in the information distribution device can extract the operation object and can controlinteraction of a controller which is represented by a remote controller device of an information receiving terminal device in real time. The operation object represents button information or link operation for an operation included in content information as described below. The operation object can be analyzed/extracted as the button information and the link information from a script included in a program in the content data before . content conversion when a program language such as computer graphics (CG) is included in the content data. Further, when the content data is mixed contents of a video, a still image, a text, and the like, the operation object can be extracted from content data after content conversion.

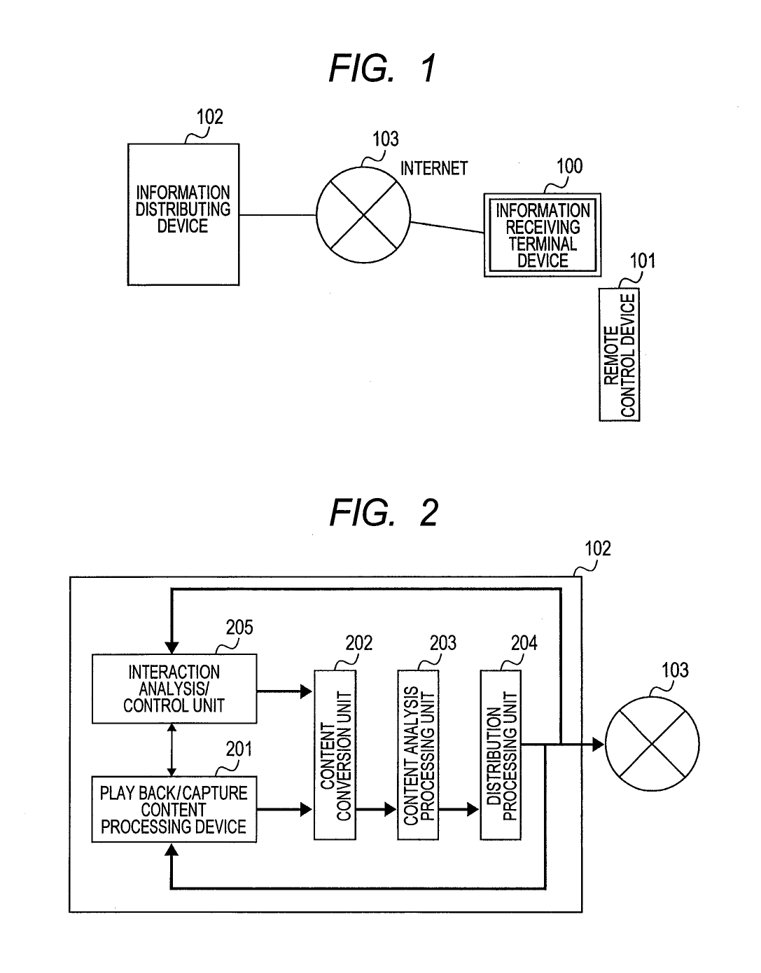

FIG. 1 is a diagram showing one example of an overall configuration of an information distribution system according to an embodiment. Further, FIG. 2 is a diagram showing one detailed configuration of an information distribution device in the information distribution system of FIG. 1.

In FIG. 1, reference numeral 100 represents an information receiving terminal device such as an IPTV, reference numeral 101 represents a remote controller device which is a controller controlling the information receiving terminal device 100, reference numeral 102 represents an information distribution device for providing an information service to the information receiving terminal device, and reference numeral 103 represents the Internet which is a communication network connecting various devices.

FIG. 2 is a functional block diagram showing one configuration example of the information distribution device 102.

In the figure, reference numeral 201 represents a playback/capture content processing device serving as a content playback processing unit that plays back Flash (registered trademark) contents which are played back in a general PC and acquires screen information of the contents and reference numeral 202 represents a content conversion unit converting formats of the contents based on device information of the information receiving terminal device 100. The content conversion unit 202 acquires the device information from an interaction analysis/control unit 205 in FIG. 2, but may be configured to receive the device information directly from the information receiving terminal device 100.

Reference numeral 203 represents a content analysis processing unit performing an overlay (overlay display) of content data with operation object information which can be operated by the remote controller, which is extracted by analyzing video stream information such as moving picture experts group (MPEG)-2, H. 264, and the like, for example, when the information receiving terminal device 100 is a TV and reference numeral 204 represents a distribution processing unit distributing a result of the overlay (overlay display) of contents with the operation object information to the Internet 103.

The interaction analysis/control unit 205 is connected to the Internet 103 and acquires, in initial connection, the device information of the information receiving terminal device 100 that requests providing information, continuously receives operation information of the remote controller device 101 operated by a user, commands selection of contents by a request (action) of the user, and further, controls the content conversion unit 202 converting the selected contents into formats suitable for the receiving terminal device 100 that presents the request.

Further, the interaction analysis/control unit 205 analyzes an operation of the remote controller device 101 with respect to management and administration information on preservation, accumulation, and update of the device information of the information receiving terminal device 100 or content information distributed from the distribution processing unit 204, acquires the operation object information extracted to the content analysis processing unit 203, and makes a database of key code information from the remote controller which is code information of the controller or screen positional information of the operation object. Further, the interaction analysis/control unit 205 controls any one content of the converted contents and unconverted contents to be selected as an operation object extraction target of the content analysis processing unit 203 according to a type of the selection commanded content.

The playback/capture content processing device 201 as the content playback processing unit may have a disk array device as a storage unit preserving data of the contents and may acquire content provided from a content provider via the Internet 103. Both have a function to play back contents provided from the storage unit such as the disk array device or a content provider.

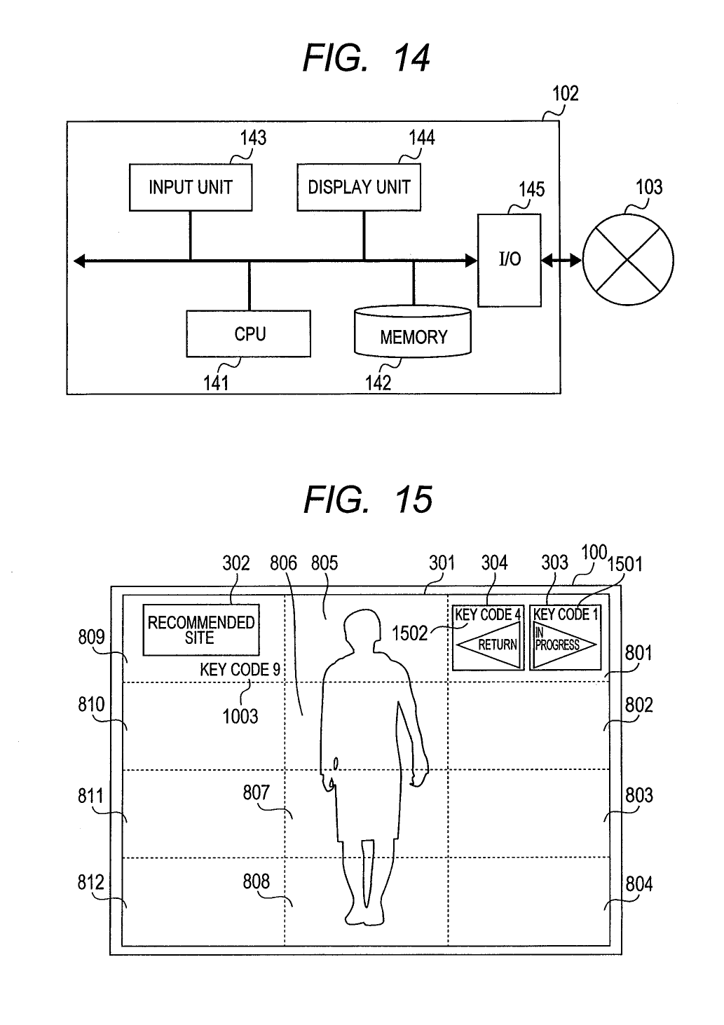

FIG. 14 shows one example of a hardware configuration of the information distribution device 102 of the embodiment. As shown in the figure, the information distribution device may be configured by a PC or a server which is a general computer. In the figure, reference numeral 141 represents a central processing unit (CPU) which is a processing unit executing various programs, reference numeral 142 represents a memory which is a storage unit of a program or data, reference numeral 143 represents an input unit such as a keyboard, or a mouse, reference numeral 144 represents an output unit such as a display, and reference numeral 145 represents an I/O interface unit. As the memory 142, a general semiconductor memory or the aforementioned disk array device is used. The CPU 141 may implement each functional block of the content playback/capture control unit 201, the content conversion unit 202, the content analysis processing unit 203, the distribution processing unit 204, and the interaction analysis/control unit 205 by executing the program stored in the memory 142. In other words, the program includes a content playback/capture program, a content conversion program, a content analysis processing program, a distribution processing program, and an interaction analysis/control program. Further, the display unit 144 as the output unit may be omitted in some cases.

Further, although not shown, the information receiving terminal device 100 constituting the system may also be implemented by the same hardware configuration. However, the information receiving terminal device 100 has a wireless sensor or an infrared sensor receiving a signal regarding a key operation of the remote controller device 101 as an input unit and further, has the display as the output unit.

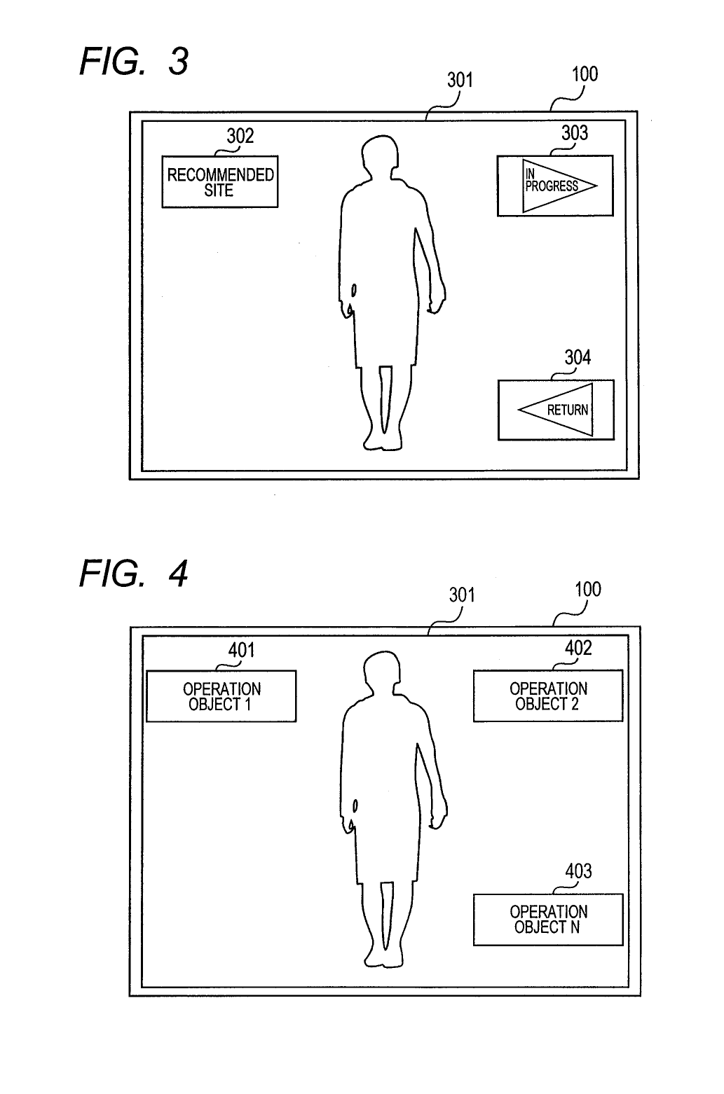

FIG. 3 mimetically shows one example of playback/capture contents as original contents distributed to the information distribution device 102. In other words, reference numeral 301 represents the playback/capture contents which are original content information for inputting content data of the playback contents displayed on the display when contents are played back with an apparatus having a playback function and a display, such as the general PC. Among the playback/capture contents 301, reference numeral 302 represents a link button of a recommended site, reference numeral 303 represents a progress-in button, and reference numeral 304 represents return button information. Further, the buttons 302, 303, and 304 are captured contents inputted as image data as described above, become video contents, and are content image data that cannot control interaction by holding down the buttons.

The buttons 302, 303, and 304 as the button information are held down like the recommended site banner button 302 to change to another site and operate the contents like the progress-in button 303 and the return button 304 and the button information may be text information such as a telop included in the contents as described above and meta information related to the contents.

In the embodiment, the playback/capture content processing device 201 of the information distribution device 102 plays back/captures the contents and converts the corresponding contents into a predetermined format to match a content format depending on the device information of the information receiving terminal device 100, thereby making it possible to provide the content information to various information terminal receiving devices 100.

FIG. 4 mimetically shows one example of a result of analyzing a captured video of playback/capture contents distributed to the information distribution device 102 in the embodiment by using a content analysis processing unit 203. In the figure, reference numeral 401 represents an operation object 1 of a result of analyzing the recommended site banner button 302 from the video contents. Reference numeral 402 represents an operation object 2 of a result of analyzing the progress-in button 303 from the video contents and reference numeral 403 represents an operation object N of a result of analyzing an operation from the video contents. The content analysis processing unit 203 extracts the information of the operation object provided as the original contents from the playback/capture contents 301 and cuts the extracted operation object information from original data as data of the original contents and rectangular information showing a position on a content screen, such that the interaction analysis/control unit makes a matching database with the recommended site 302, the progress-in button 303, and the return button 304 which are the operation buttons.

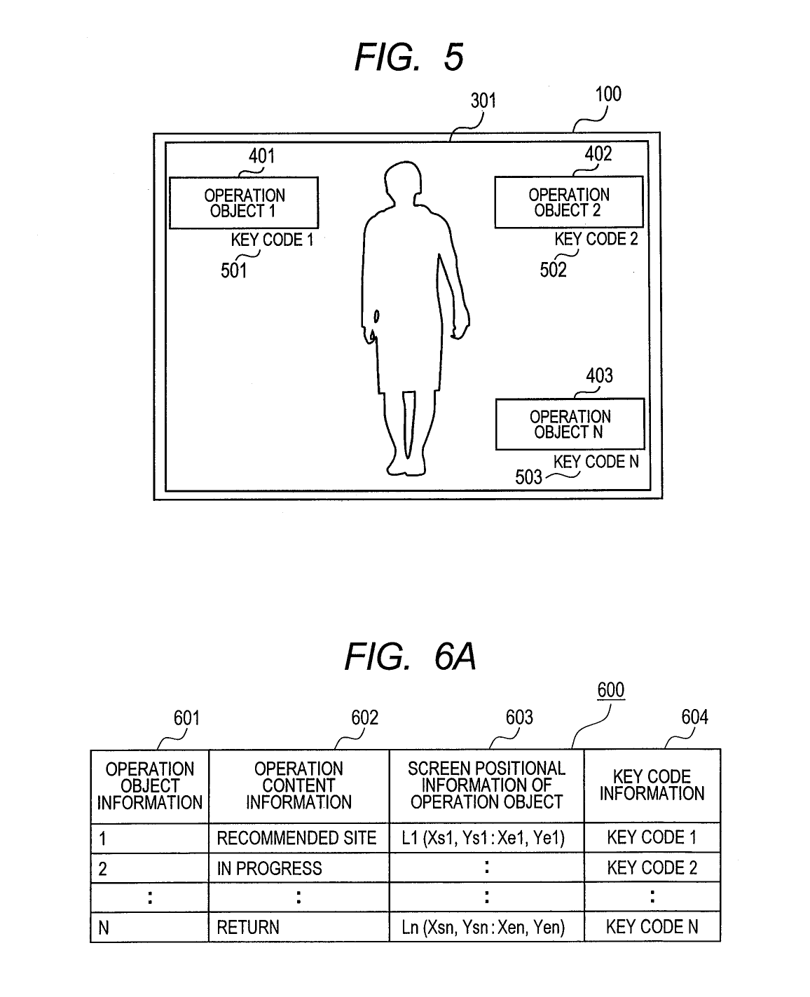

FIG. 5 shows one example of a key code overlay display (overlay display) of the remote controller device 101 distributed to the distribution processing unit 204 of the information distribution device 102 of the embodiment. Reference numeral 501 represents a key code 1 matching the operation object 1, reference numeral 502 represents a key code 2 matching the operation object 2, and reference numeral 503 represents the key code N matching the operation object N. The content analysis processing unit 203 generates a matching chart with the operation object information extracted from the content information of an analysis result of the captured video based on the device information of the information receiving terminal device 100 and the key code information which is the action of the remote controller device 101.

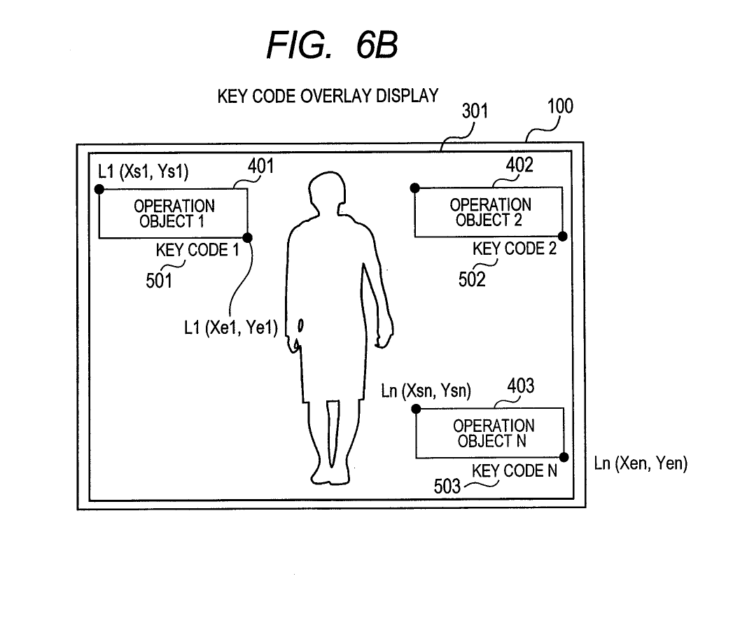

Reference numeral 600 of FIG. 6A shows one example of a database (hereinafter, referred to as a DB) table of an operation object/key code chart generated by the aforementioned content analysis processing unit 203. Reference numerals 601, 602, 603, and 604 represent operation object information, operation content information, screen positional information Ln(Xsn, Ysn:Xen, Yen) of the operation object representing coordinates of a start point and an end point, and key code information of the remote controller device 101, respectively.

FIG. 6B is a diagram mimetically showing one example of a positional relationship of the screen positional information 603 of the operation object shown in FIG. 6A.

In FIG. 6A, the operation object information 601 is given every operation object extracted by the content analysis processing unit 203. The operation content information 602 matching each of the operation object information 601 in the embodiment represents operation contents of the recommended site banner button 302, the progress-in button 303, and the return button 304 acquired when the playback/capture content processing device 201 plays back the original contents. Further, the screen positional information 603 of the operation object represents the screen positional information of the operation object and in FIGS. 6A and 6B, the screen positional information 603 of the operation object is represented as upper left and lower right coordinate information of rectangular area information of the operation object. As shown in FIG. 6B, the positional information 603 represents upper left positional information as L1(Xs1, Ys1) and lower right positional information of the operation object 401 as L1(Xe1, Ye1) and similarly, represents upper left positional information of the operation object N as Ln(Xsn, Ysn) and lower right positional information of the operation object N as Ln(Xen, Yen).

In the embodiment, the key code information 604 represents a key code of the remote controller device 101 and is made to the database by matching the buttons of the numeric keys of the remote controller device 101. By the DB 600, the operation object of the visualized capture content may match the key code of the remote controller device 100 and the interaction analysis/control unit 205 controls the playback/capture content processing device 201 based on the operation information matching the action of the remote controller device 101 of the information receiving terminal device 100 to thereby ensure interactivity of the content operation action by the remote controller device 101 of the information receiving terminal device 100. Further, the DB 600 may be provided in a type to share each control unit and processing unit constituting the information distribution device 102 and for example, the DB 600 is stored in a memory 142 of FIG. 14 to acquire an accessible state in various programs executed by a CPU 141.

Further, respective functional blocks of the information distribution device 102 may be separated according to the number of users such that respective functions may be constructed in the computers such as the plural PCs, and the respective functions may be implemented as a function of the PC to collectively control plural functions.

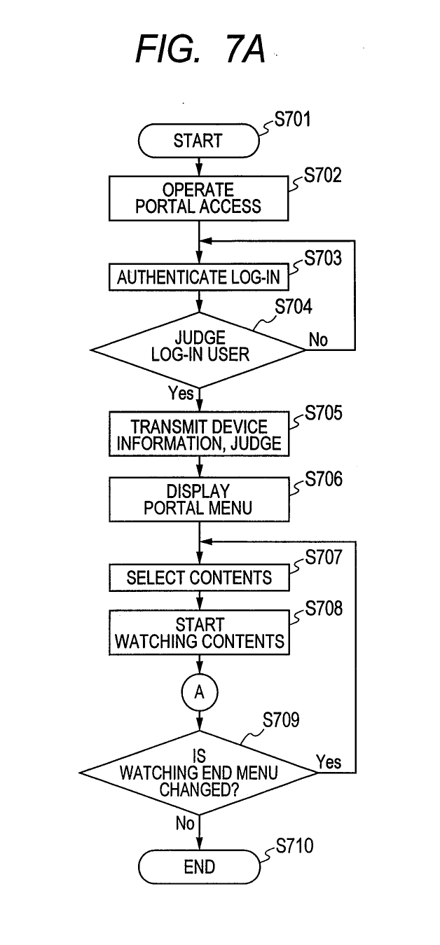

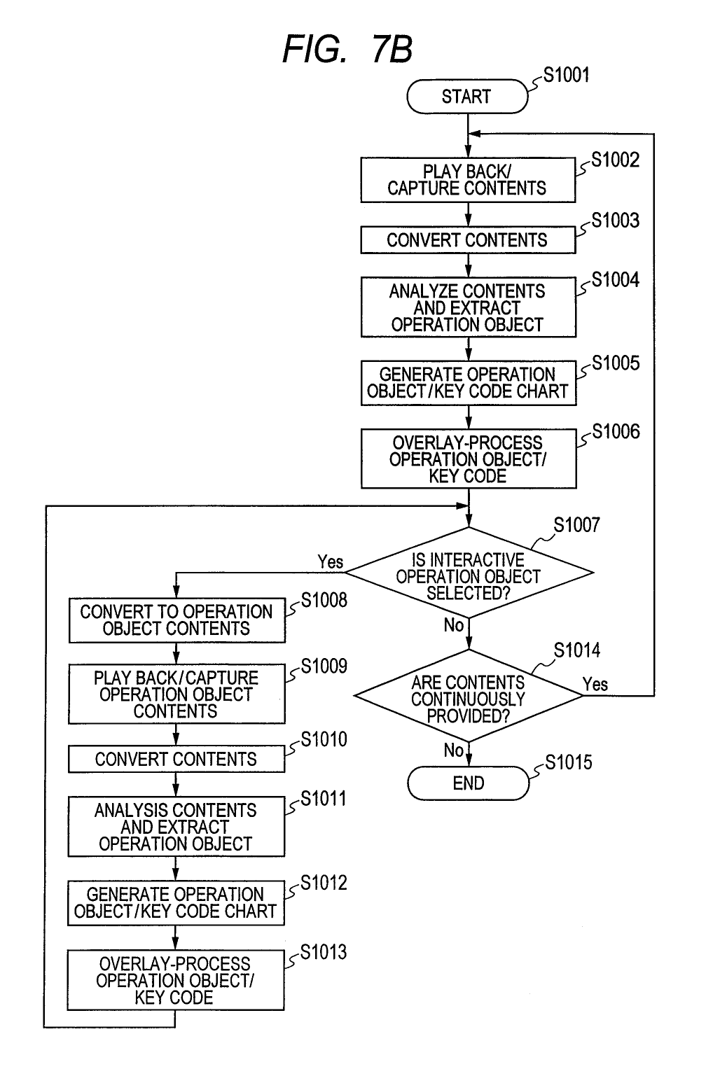

Subsequently, with reference to FIGS. 7A and 7B, a processing flow of each functional block of the playback/capture content processing device 201, the content conversion unit 202, the content analysis processing unit 203, and the distribution processing unit 204 in the information distribution device 102 of the embodiment will be described.

First, with reference to the processing flow of FIG. 7A, a primary processing routine in an information service of the system in the embodiment will be described. After power is turned on, when processing starts from an initial screen (S701), first, for example, a portal access operation (S702) is performed by holding down an Internet access button, a log-in authentication code for judging a service contractor or not is transmitted from the remote controller device 101 and the information terminal device 100 and log-in authentication (S703) and log-in user judgment (S704) are performed, and as a result, preparation for enjoying the service is completed. If the service contractor is not a regular contract user or log-in information is inputted by mistake (No), the process returns to log-in authentication processing to perform the log-in authentication processing again. If the service contractor is a service enjoying user (Yes), the device information of the information terminal device 100 is transmitted and judged (S705), a service portal screen is displayed (S706), and the user performs content selection (S707) as the action, and performs a start of content watching (S708). Further, processing after the start of the content watching, that is, processing of a circle A of FIG. 7A will be described below in detail with reference to FIG. 7B.

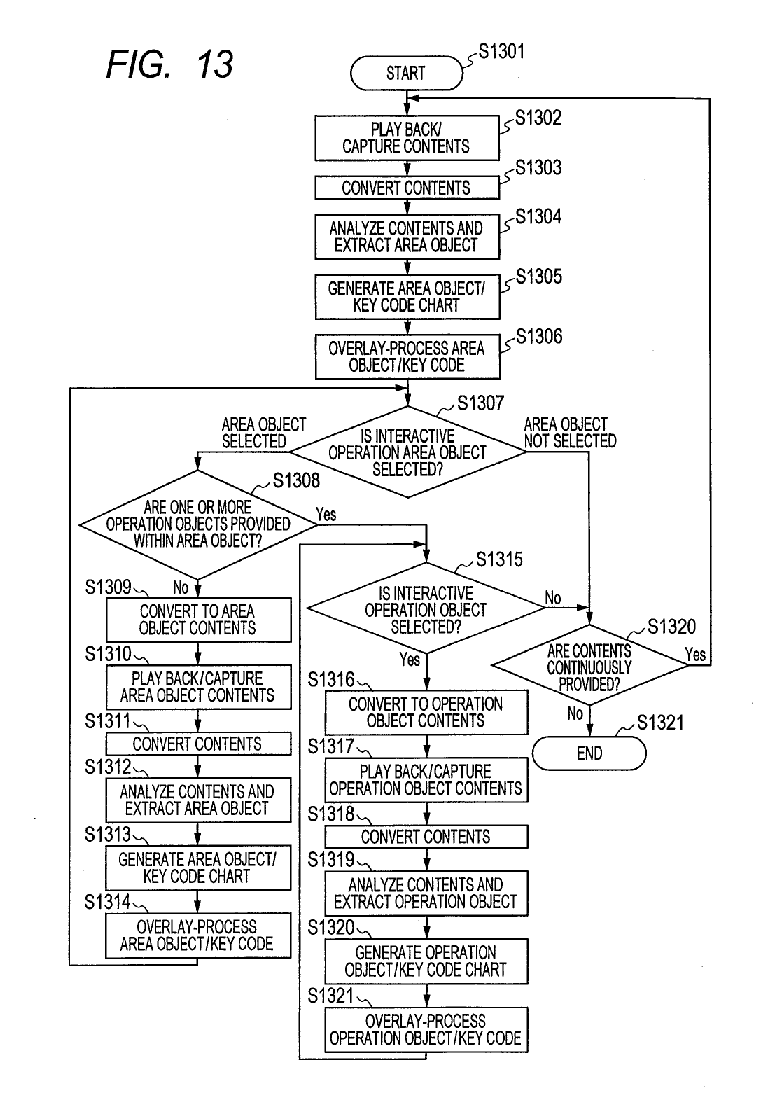

After the start of the content watching, processing of FIG. 7B or processing of FIG. 13 of a second embodiment is performed and a watching end as an end of the service and judgment processing of menu change (S709) are performed and the process operates to return to an end (S710) or the content selection (S707). Portal accesses corresponding to plural service providers may be performed in the same process and an access to a predetermined portal is available by the portal access operation (S702).

Subsequently, the processing after the start of the content watching, that is, the processing of the circle A of FIG. 7A will be described with reference to FIG. 7B. First, in the processing flow of FIG. 7B, when the processing starts (S1001), the interaction analysis/control unit 205 controls the processing based on the operation information of the remote controller device 101 and the playback/capture content processing device 201 starts the playback/capture of the contents (S1002). The content playback/capture operation in the embodiment represents processing of first playing back the contents by using a device which can play back the contents and extracting the content information in order to play back content data which can be played back by using a limited device through a predetermined device which cannot play back the content data as it is. For example, the content playback/capture operation represents processing of extracting the content information of the contents of the Flash (registered trademark) played back in the PC because the contents of the Flash (registered mark) may be played back in the PC, but may not be played back in a current TV. This is the same as processing of remotely receiving the content information into a possessed PC from a server and playing back the contents through the possessed device in a thin client PC without a hard disk device having an strengthened security function.

At this moment, content data which is played back and captured in a center side becomes the contents shown in FIG. 3 and is played back while the recommended site banner button 302, the progress-in button 303, or the return button 304 which can be subjected to the interactive operation is available. In addition, content conversion processing (S1003) is performed based on the device information of the information receiving terminal device 100 and MPEG-2, H. 264, and resolution are optimally converted from a content format which can be watched by the information receiving terminal device 100, for example, the capture contents in the TV. At this moment, as shown in FIG. 4, an interactive operation button becomes one video.

In the embodiment, in a predetermined information receiving terminal device 100, content conversion processing (S1003) of contents which cannot be played back in the related art is performed in the center side, that is, the information distribution device side and the content can be played back by using the predetermined information receiving terminal device and further, provided without damaging interactivity. Therefore, the content analysis processing unit 203 analyzes the playback capture content information and performs operation object extraction processing (S1004) of the recommended site button 302 included in the contents. As a result, when the operation object exists, operation object/key code chart generation (S1005) is executed and content analysis processing unit 20 executes operation object/key code overlay processing (S1006) as shown in FIG. 5. Accordingly, the contents are converted into contents which can be played back by the predetermined information receiving terminal device 100 and further, the interactive operation to the predetermined information receiving terminal device can be implemented.

Further, in the processing flow, after the content playback/capture processing (S1002), the content conversion processing (S1003) is performed and thereafter, the content analysis and operation object extraction processing (S1004) is performed, but as described above, when the information of the operation object which is provided as the original contents may be extracted directly from the original contents before conversion, the control unit 205 controls the processing target of the content analysis processing unit 20 so as to extract the operation object from the original contents acquired through the content playback processing.

Subsequently, the selection judgment processing (S1007) of the interactive operation object which is the action by the user is performed and if the operation object is not selected (No), it is judged whether the contents are continued (S1014) and if the contents are continued (Yes), the processing is continued and if the contents are not continued (No), the process ends (S1015) and the processing of FIG. 7A is performed and the process is transited to the watching end menu change (S709).

Further, if the operation object is selected through the interactive operation object selection judgment processing (S1007) (Yes), conversion into the operation object contents relating to the selected operation object (S1008) is performed and processing of S1009 to S1013 which is the same processing as S1002 to S1006 is performed with respect to the operation object contents after conversion and processing is repeatedly executed to correspond to the interactive operation of the user.

### Second Embodiment

The second embodiment is a diagram showing an information distribution system that can define at least a part of a display screen of an information receiving terminal device as an area object according to an arrangement of a key code matching code information for controlling a remote controller device and control interaction accompanied with an operation of the remote controller device in real time.

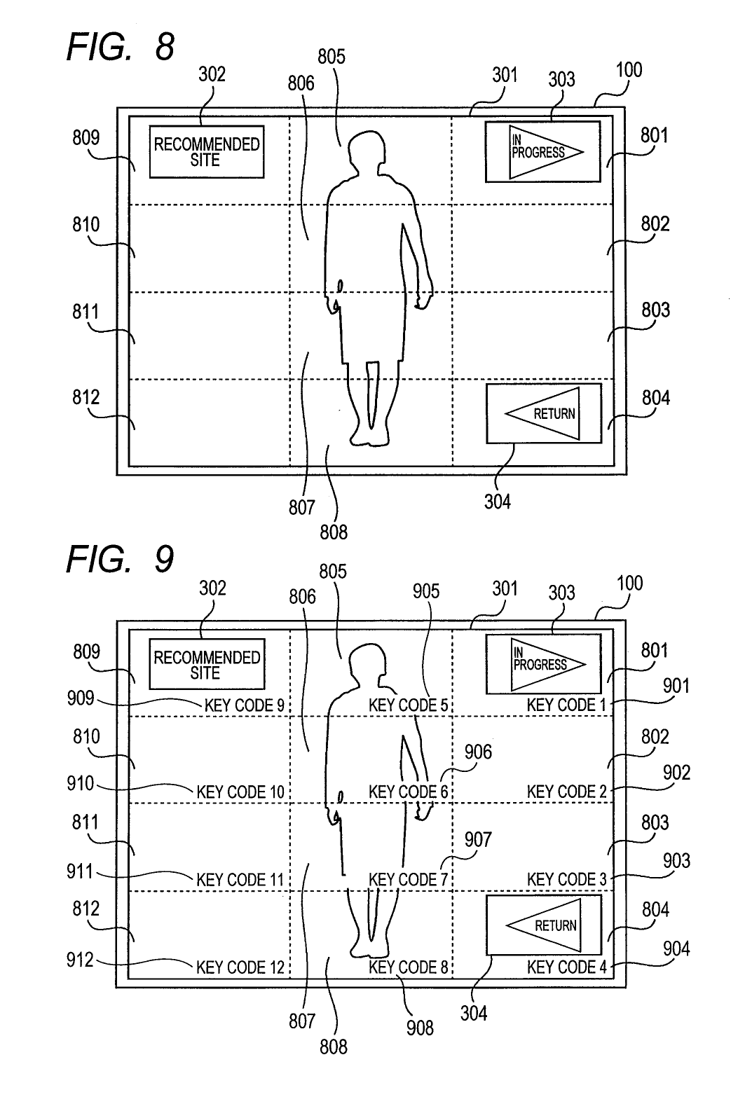

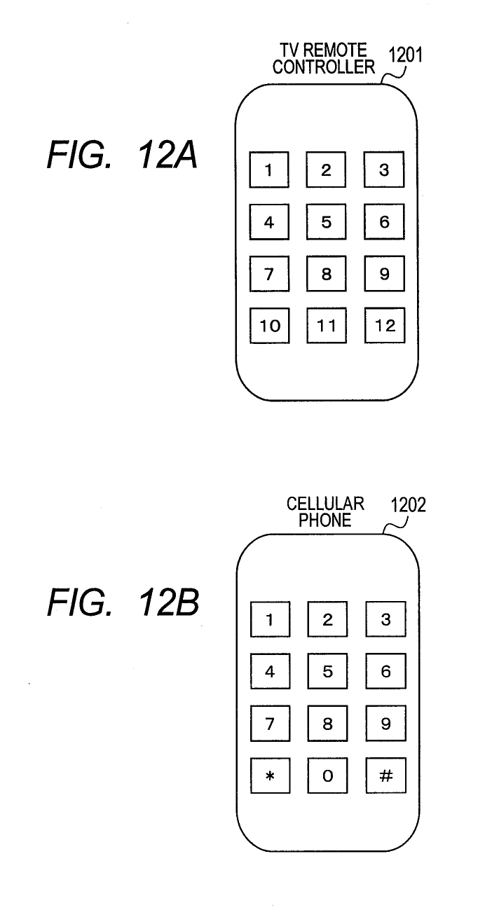

Similar to the first embodiment, FIGS. 8, 9, and 10 show contents playback/capture contents using the playback/capture contents shown in FIG. 3 as the original, an area object, an area object overlay display 1, and an area object overlay display 2, FIG. 11 shows a DB of the area object and the operation object/key code chart, and FIGS. 12A and 12B show examples of a key arrangement of a TV remote controller which is one example of the remote controller device 101 and a key arrangement of the portable terminal, respectively.

FIG. 8 shows one example in which the content screen is divided into 12 in 801 to 812 that represent area object 1 to area object 12. As can be seen in the figure, the progress-in button 303 is provided in the area object 801, the return button 304 is provided in the area object 804, and the recommended site banner button 302 is provided in the area object 809.

FIG. 9 shows an overlay display of the key code information of the remote controller device 101 matching the aforementioned area object. Reference numerals 901 to 902 represent key code 1 to key code 12 of the remote controller device 101 matching the area object information 801 to 809.

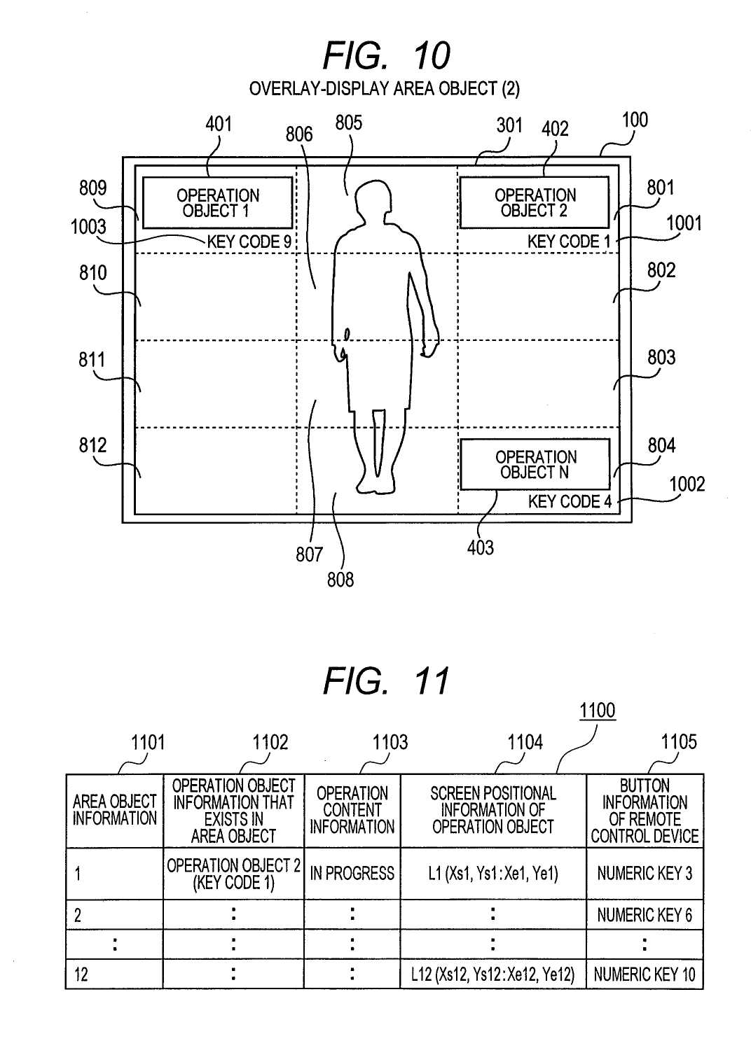

FIG. 10 is a modified example of FIG. 9 and shows a case where the key code of the remote controller device 101 is overlay-displayed only when the operation object is provided in the area object.

Reference numerals 1001 to 1003 represent the key code 1 for an operation object 2402 provided in an area object 1801, the key code 4 for an operation object N403 provided in an area object 4804, and the key code 9 for an operation object 1401 provided in an area object 9809. As a result, only the key code with the operation object is presented to the user without overlay-displaying the key code matching the area object at all times, thereby improving operability. According to the embodiment, the information is made to a DB of the area object and the operation object/key code chart, such that the content can be operated by holding down the numeric keys of the remote controller device 101 by matching the key arrangement of the remote controller device 101 with the area of the display screen.

FIG. 11 shows a DB 1100 of the area object and the operation object/key code chart in the second embodiment described above. The DB 1100 makes a DB of the area object information, the operation object information provided in the area object, the operation content information, the screen positional information of the operation object, and the button information of the remote controller device represented by 1101, 1102, 1103, 1104, and 1105, respectively.

In FIGS. 12A and 12B, reference numeral 1201 represents the key arrangement of the TV remote controller and reference numeral 1202 represents the key arrangement of the portable terminal. In the description of the embodiment, the DB 1100 of the area object and the operation object/key code chart of FIG. 11 is shown as one example of the key arrangement 1201 of the TV remote controller, but the key code provided in the remote controller device 101 can be arbitrarily allocated according to the DB chart and the key code is allocated to a key which the user easily holds down to thereby improve operability.

Subsequently, with reference to FIGS. 13 and 14, one example of processing of the playback/capture content processing device 201, the content conversion unit 202, the content analysis processing unit 203, and the distribution processing unit 204 by the area object in the information distribution device 102 of the embodiment will be described.

A processing flow of FIG. 13 is to perform processing of the area object of the circle A in the processing flow of FIG. 7A. In the embodiment, in addition to the operation of the operation object, the interactive operation is implemented by using display screen area information. In processing of S1302 to S1306, as shown in FIG. 9, the screen area of the operation object performing the interactive operation is divided into predetermined areas and the interactive operation by the area object included in the area is implemented. In a processing flow other than the area object/key code overlay processing (S1306) by the operation object that is provided in the divided screen area, the same processing as the processing described in FIG. 7B is basically performed, and as a result, a description thereof will be omitted.

FIG. 15 relates to a modified example of the second embodiment and shows one example of an area object overlay display 3 when the area object and the operation object are jointly used. Reference numeral 1501 represents a key code 1 of the progress-in button 303 of the plural operation objects that are provided in the same area object and reference numeral 1502 represents a key code 4 of the return button 304 of the plural operation objects that are provided in the same area object.

As can be seen in FIG. 15, a key code 9•1003 that enables an operation of the remote controller device 101 through the recommended site banner button 302 is displayed in the area object 809 and if the number of operation objects selected by the remote controller device 101 within the area object is one, the key code 9 of the remote controller is made to the DB, such that a numeric key 1 matches from the key arrangement 12 of the TV remote controller corresponding thereto. Two operation objects of the progress-in button 303 and the return button 304 are provided in the area object 1801 and a key code 1•1501 and a key code 4•1502 operate to be overlay-displayed.

### Third Embodiment

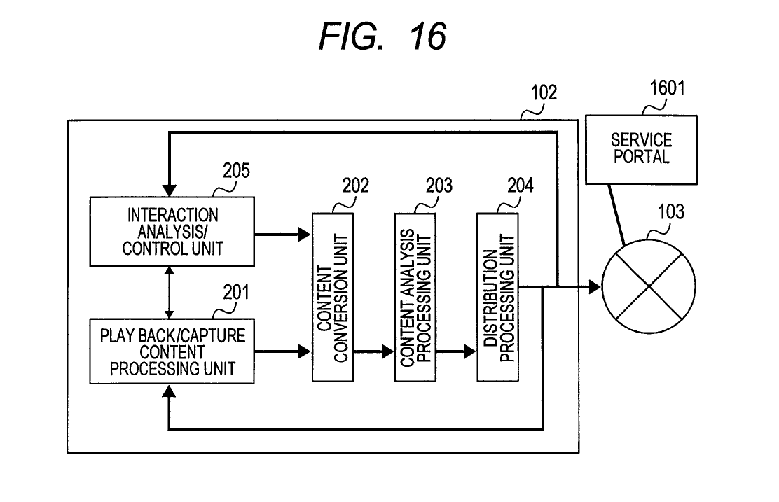

FIG. 16 relates to a third embodiment and is a diagram showing one configuration of an overall system when a service is provided by a service portal. Reference numeral 1601 represents a service portal which the information receiving terminal device 100 accesses when using various information such as a user's service subscription situation or log-in information for enjoying the service, access authentication information, and the like and the service.

In FIG. 16, the service portal 1601 accesses the Internet 103, but the service portal 1601 may be constructed in the information distribution device 120. When the service is provided to the information receiving terminal device by using a network, a function such as the service portal 1601 is required.

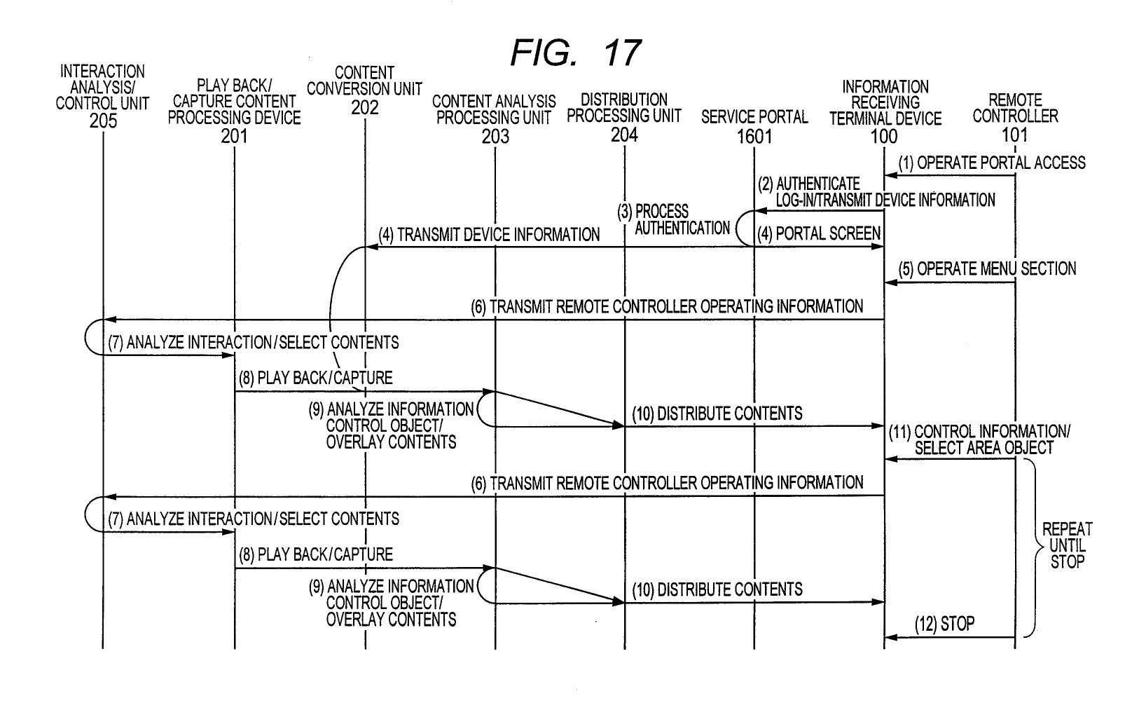

FIG. 17 is a diagram showing one example of a processing sequence in each processing device constituting the system at the time of providing the service by using the service portal 1601 via the Internet 103. Further, for convenience, figures in a circle in the figure are described as figures. As shown in the processing flow of FIG. 7A, the information receiving terminal device 100 (2) transmits log-in authentication/device information to the service portal 1601 by (1) a portal access operation from the remote controller device 101, and the service portal 1601 (3) performs authentication processing to judge where there is a regular service user and distribute (4) a portal screen for enjoying the service to the information receiving terminal device 100, and further, (4)′ transmit the device information to the content conversion unit 202 of the information distribution system 102 directly or indirectly, and matches a content format which the information receiving terminal 100 can watch.

When the remote controller device 101 (5) performs a menu selection operation by using the portal screen displayed on the information receiving terminal device 100, the information receiving terminal device 100 transmits remote controller operation information to the interaction analysis/control unit 205 and the interaction analysis/control unit 205 (7) controls interaction analysis and content selection. The playback/capture content processing device 201 starts (8) playback/capture based thereon. The content conversion unit 202 performs conversion of the content format based on (4)′ the device information which is transmitted above and the content analysis processing unit 203 (9) performs information control object analysis/content overlay processing, overlays content data and key code information for operating the remote controller, (10) distributes the contents from the distribution processing unit 204, and executes the process to be repeated until the same sequence processing (12) stops by the information control/area object selection.

As described above, according to the present invention, in the remote controller device 101, the contents are converted into the content format which the information receiving terminal device can watch, such that the visualized contents can be interactively operated and the service can be provided to even all kinds of information receiving terminal devices without individually producing the contents.

### INDUSTRIAL APPLICABILITY

The present invention is useful as a method and an information distribution system for processing bidirectional operations by a user's remote controller operation, and more particularly, an information distribution technology that facilitates an operation control of a user's remote controller in the information distribution system.

### REFERENCE SIGNS LIST

100 . . . Information receiving terminal device
101 . . . Remote controller device
102 . . . Information distribution device
103 . . . Internet
201 . . . Content playback/capture control unit
202 . . . Content conversion unit
203 . . . Content analysis processing unit
204 . . . Distribution processing unit
301 . . . Playback/capture contents
302 . . . Recommended site button
303 . . . Progress-in button
304 . . . Return button
401 . . . Operation object 1
402 . . . Operation object 2
403 . . . Operation object 3
501 . . . Key code 1
502 . . . Key code 2
503 . . . Key code n
801-812 . . . Area object
901-912 . . . Key code of area object
1001-1013 . . . Key code of operation object provided in area object
1201 . . . TV remote controller
1202 . . . Portable terminal
1501, 1502 . . . Key code of operation object provided in the same area object
1601 . . . Service portal

1. An information distribution device distributing contents to an information receiving terminal device, comprising:
an interaction analysis/control unit analyzing a command of the information receiving terminal device;
a content playback processing unit following control of the interaction analysis/control unit and playing back content data;
a content conversion unit converting a format of the content data based on device information of the information receiving terminal device;
a content analysis processing unit analyzing the content data, extracting an object in the content data, and overlaying the extracted object to the content data converted by the content conversion unit; and
a distribution processing unit distributing the content data to which the object is overlaid.

2. The information distribution device according to claim 1, wherein the content analysis processing unit analyzes the content data converted by the content conversion unit to acquire the object.

3. The information distribution device according to claim 1, wherein the content analysis processing unit analyzes the content data played back by the content playback processing unit to acquire the object.

4. The information distribution device according to claim 1, further comprising:
a storage unit,
wherein the storage unit accumulates a database that performs matching screen positional information of the object and operation content information.

5. The information distribution device according to claim 4, wherein:
the object is an operation object, and
the database stores operation code information of a controller controlling the information receiving terminal device receiving the content data to match the operation object.

6. The information distribution device according to claim 1, wherein the interaction analysis/processing unit controls the content playback processing unit to convert the content data to match the selected object when the command of the information receiving terminal device is selection of the object.

7. An information distribution device distributing contents to an information receiving terminal device, comprising:
a processing unit processing content data; and
a storage unit,
wherein the processing unit plays back the content data based on a command from the information receiving terminal device, converts a format of the content data which is played back in accordance with device information of the information receiving terminal device, analyzes the content data, extracts an object in the content data, overlay-processes the extracted object to the converted content data, and distributes the content data which is overlay-processed.

8. The information distribution device according to claim 7, wherein the processing unit converts the content data to match the selected object when the command from the information receiving terminal device is based upon selection of the object which is overlaid.

9. The information distribution device according to claim 7, wherein the object is an operation object.

10. The information distribution device according to claim 7, wherein the object is an area object.

11. The information distribution device according to claim 10, wherein the area object is an object displayed on a display screen of a display unit of the information receiving terminal device to match operation code information of a controller controlling the information receiving terminal device.

12. The information distribution device according to claim 7, wherein the storage unit accumulates a database that performs matching of the object and operation content information.

13. A method for processing bidirectional operations in an information distribution device with a processing unit distributing contents to an information receiving terminal device, wherein:
the processing unit plays back the content data based on a command from the information receiving terminal device, converts a format of the content data which is played back in accordance with device information of the information receiving terminal device, analyzes the content data, extracts an object in the content data, overlay-processes the extracted object to the converted content data, and distributes the content data which is overlay-processed to the information receiving terminal device.

14. The method for processing bidirectional operations according to claim 13, wherein the processing unit analyzes the content data and extracts an operation object matching a key of a remote controller device controlling the information receiving terminal device as the object.

15. The method for processing bidirectional operations according to claim 13, wherein the processing unit analyzes the content data and extracts an area object matching a key arrangement of the remote controller device controlling the information receiving terminal device as the object.

16. The method for processing bidirectional operations according to claim 13, wherein the processing unit converts the content data to match the selected object when the command of the information receiving terminal device is selection of the object.

17. The method for processing bidirectional operations according to claim 13, wherein the processing unit selects any one content datum before and after format conversion as the content data analyzed to extract the object, based on a type of the content data which is played back.
